(19) United States
(12) Patent Application Publication
(10) Pub. No.: US 2017/0115736 A1
(43) Pub. Date: Apr. 27, 2017

(54) Photo-Based Unlock Patterns

(71) Applicant: Google Inc., Mountain View, CA (US)

(72) Inventors: Nirmal Patel, Sunnyvale, CA (US); Steven John Lee, San Francisco, CA (US)

(21) Appl. No.: 13/860,416

(22) Filed: Apr. 10, 2013

(51) Int. Cl. G06F 3/01

(52) U.S. Cl. CPC G06F 3/017

(57) ABSTRACT

Embodiments described herein may help to provide a lock-screen for a computing device. An example method involves: (a) displaying an image and an input region that is moveable over the image, (b) based on head-movement data, determining movement of the input region with respect to the image, (c) during the movement of the input region, receiving gesture data corresponding to a plurality of gestures, (d) determining an input pattern, wherein the input pattern comprises a sequence that includes a plurality of locations in the image, wherein each location in the sequence is a location of the input region in the image at or near a time of a corresponding one of the gestures, (e) determining whether or not the input pattern matches a predetermined unlock pattern, and (f) if the input pattern matches the predetermined unlock pattern, then unlocking the computing device.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are increasingly prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as “wearable computing.” In the area of image and visual processing and production, in particular, it has become possible to consider wearable displays that place a graphic display close enough to a wearer's (or user's) eye(s) such that the displayed image appears as a normal-sized image, such as might be displayed on a traditional image display device. The relevant technology may be referred to as “near-eye displays.”

Wearable computing devices with near-eye displays may also be referred to as “head-mountable displays” (HMDs), “head-mounted displays,” “head-mounted devices,” or “head-mountable devices.” A head-mountable display places a graphic display or displays close to one or both eyes of a wearer. To generate the images on a display, a computer processing system may be used. Such displays may occupy a wearer's entire field of view, or only occupy part of wearer's field of view. Further, head-mounted displays may vary in size, taking a smaller form such as a glasses-style display or a larger form such as a helmet, for example.

Emerging and anticipated uses of wearable displays include applications in which users interact in real time with an augmented or virtual reality. Such applications can be mission-critical or safety-critical, such as in a public safety or aviation setting. The applications can also be recreational, such as interactive gaming. Many other applications are also possible.

### SUMMARY

Example embodiments help to provide interfaces for unlocking a computing device, and in particular, for unlocking a head-mountable device (HMD). In particular, an HMD may display an image, which could be a stock image or an image provided by the user. A user may then use a combination of head movements and gestures on a touchpad to enter an unlock pattern that is based on features in the image. In example embodiments, the unlock pattern may be a particular sequence of features in the picture, or a particular sequence that includes one or more particular features and one or more paths between certain locations in the picture (these locations and paths may be visually portrayed as “dots” and “dashes” being drawn over the image).

In one aspect, a computer-implemented method involves: (a) while a computing device is locked, causing a display of the computing device to display an image and an input region that is moveable over the image, (b) receiving head-movement data that is indicative of head movement, (c) based at least in part on head-movement data, determining one or more movements of the input region with respect to the image, (d) receiving gesture data corresponding to a plurality of gestures, wherein the gesture data is received during the one or more movements of the input region with respect to the image, (e) determining an input pattern that comprises a sequence of locations in the image, wherein each location in the sequence is a location of the input region in the image at or near a time of a corresponding one of the gestures, (f) determining whether or not the input pattern matches a predetermined unlock pattern, wherein the predetermined unlock pattern comprises a predetermined sequence of two or more locations in the image, (g) if the input pattern matches the predetermined unlock pattern, then unlocking the computing device, and (h) if the input pattern does not match the predetermined unlock pattern, then refraining from unlocking the computing device.

In another aspect, a non-transitory computer readable medium has stored therein instructions executable by a computing device to cause the computing device to perform functions comprising: (a) while the computing device is locked, displaying an image and an input region that is moveable over the image, (b) receiving head-movement data that is indicative of head movement, (c) based at least in part on head-movement data, determining one or more movements of the input region with respect to the image, (d) receiving gesture data corresponding to a plurality of gestures, wherein the gesture data is received during the one or more movements of the input region with respect to the image, (e) determining an input pattern, wherein the input pattern comprises a sequence that includes a plurality of locations in the image, wherein each location in the sequence is a location of the input region in the image at or near a time of a corresponding one of the gestures, (f) determining whether or not the input pattern matches a predetermined unlock pattern, wherein the predetermined unlock pattern comprises a predetermined sequence of two or more locations in the image, (g) if the input pattern matches the predetermined unlock pattern, causing the computing device to unlock, and (h) if the input pattern does not match the predetermined unlock pattern, then refraining from unlocking the computing device.

In a further aspect, a computing device may include a display interface to a display, a non-transitory computer readable medium, and program instructions stored on the non-transitory computer readable medium and executable by at least one processor to: (a) while the computing device is locked, cause the display to display an image and an input region that is moveable over the image, (b) receive head-movement data that is indicative of head movement, (c) based at least in part on head-movement data, determine one or more movements of the input region with respect to the image, (d) during the one or more movements of the input region with respect to the image, receive gesture data corresponding to a plurality of gestures, (e) determine an input pattern, wherein the input pattern comprises a sequence that includes a plurality of locations in the image, wherein each location in the sequence is a location of the input region in the image at or near a time of a corresponding one of the gestures, (f) determine whether or not the input pattern matches a predetermined unlock pattern, wherein the predetermined unlock pattern comprises a predetermined sequence of two or more locations in the image, (g) if the input pattern matches the predetermined unlock pattern, unlock the computing device, and (h) if the input pattern does not match the predetermined unlock pattern, then refrain from unlocking the computing device.

In another aspect, a computer-implemented method involves: (a) while a computing device is locked, causing a display of the computing device to display an image and an input region that is moveable over the image, (b) based at least in part on head-movement data, determining one or more movements of the input region with respect to the image, (c) during the one or more movements of the input region with respect to the image, receiving gesture data corresponding to one or more first gestures and one or more second gestures, (d) determining an input pattern that comprises a sequence that includes both: (i) one or more locations in the image, each location in the sequence is a location of the input region in the image at or near a time of a corresponding one of the one or more first gestures, and (ii) one or more paths in the image, wherein each path corresponds to movement of input region with respect to the image during a corresponding one of the one or more second gestures, (e) determining whether or not the input pattern matches a predetermined unlock pattern, wherein the predetermined unlock pattern comprises a predetermined sequence of at least one location in the image and at least one path in the image, (f) if the input pattern matches the predetermined unlock pattern, then initiating an unlock procedure, and (g) if the input pattern does not match the predetermined unlock pattern, then refraining from initiating an unlock procedure.

In yet another aspect, a computer-implemented method involves: (a) while a computing device is locked, causing a display of the computing device to display an image and an input region that is moveable over the image, wherein a predetermined unlock pattern comprises a first path, and wherein the first path is defined by a predetermined sequence of three or more locations in the image, (b) receiving head-movement data that is indicative of head movement, (c) based at least in part on the head-movement data, determining one or more movements of the input region with respect to the image, (d) determining a second path through the image that is defined at least in part by the one or more movements of the input region, (e) based at least in part on a determination as to whether or not the second path comprises the predetermined sequence of the three or more locations in the image, determining whether or not the second path matches the first path, (f) if the second path matches the first path, then initiating an unlock procedure, and (g) if the second path does not match the first path, then refraining from initiating an unlock procedure.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1A illustrates a wearable computing system according to an example embodiment.

FIG. 1B illustrates an alternate view of the wearable computing device illustrated in FIG. 1A.

FIG. 1C illustrates another wearable computing system according to an example embodiment.

FIG. 1D illustrates another wearable computing system according to an example embodiment.

FIGS. 1E to 1G are simplified illustrations of the wearable computing system shown in FIG. 1D, being worn by a wearer.

FIG. 2A is a simplified block diagram of a computing device according to an example embodiment.

FIG. 2B shows a projection of an image by a head-mountable device, according to an example embodiment.

FIG. 3 is a flow chart illustrating a method, according to an example embodiment.

FIG. 4 is an illustration of a lock-screen, according to an example embodiment.

FIGS. 5A to 5E illustrate a sequence of screenshots of a display, as a user enters the unlock pattern that was shown in FIG. 4.

FIG. 6 is a flow chart illustrating a method, according to an example embodiment.

FIG. 7 is an illustration of another lock-screen, according to an example embodiment.

FIG. 8 is a flow chart illustrating a method, according to an example embodiment.

FIG. 9 is an illustration of another lock-screen, according to an example embodiment.

### DETAILED DESCRIPTION

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the following detailed description, reference is made to the accompanying figures, which form a part thereof. In the figures, similar symbols typically identify similar components, unless context dictates otherwise. Other embodiments may be utilized, and other changes may be made, without departing from the spirit or scope of the subject matter presented herein.

The example embodiments described herein are not meant to be limiting. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

As noted above, example embodiments help to provide interfaces for unlocking a computing device, such as a head-mountable device (HMD) or a mobile phone. For example, when an HMD is locked, the HMD may display a “lock-screen” interface with an image, via which an HMD wearer can input an unlock pattern to unlock the HMD. In an example embodiment, the wearer may use a combination of head movements and gestures on a touchpad to input the unlock pattern. For instance, the wearer may use head movements to move an input region with respect to the displayed image, and use gestures on touchpad to indicate certain image locations (e.g., certain features in the image) and/or paths between certain image locations that make up the unlock pattern.

In some embodiments, a predetermined unlock pattern may be defined as a sequence of two or more locations in the image. In such an embodiment, a user could predefine a sequence of features in an image that make up an unlock pattern, which the user would then need to identify in the correct order to unlock the device.

To facilitate entry of such an unlock pattern, the HMD may display a graphic icon over the image, which indicates an input region. The HMD's user may move the icon (and thus the input region) with respect to the image via head movements, and input a particular location in the image by tapping a touchpad when the input region is over the location. Thus, to select a particular location in the image, the user can move their head until the input region is over the particular location, and then tap the HMD's touchpad (which may be mounted on the side of the HMD). The user can repeat this process using head-movements and tapping the touchpad to input the sequence of locations making up the predetermined lock pattern.

In some embodiments, a predetermined unlock pattern may be defined as a sequence that includes both: (a) one or more locations in the image and (b) one or more paths in the image. For example, a user could pick out a sequence that includes two image features and a line or path between two other image features. To allow for identification of features and paths in the image, the HMD may again display an input region over the image, and the HMD's user may again move the input region with respect to the image via head movements. The user may input particular locations in the image in the same way (e.g., by tapping a touchpad when the input region is over the location). To input a particular path in the image, the user may execute a “tap-and-hold” gesture while using head movement to move the input region along the desired path in the image.

In other embodiments, the unlock pattern may be defined as a particular path through the image. In particular, the path may start at a start location, run through one or more intermediary locations, and conclude at an end location. To enter such an unlock sequence, the user tap the HMD's touchpad at the starting location of the path, and then use head movements to move the input region along a path that in the image that includes one or more intermediary locations (without holding their finger on the touchpad), and then tap the touchpad when the input region is at the end location in order to indicate that the unlock pattern is complete. Note that in such an embodiment, correct entry of the unlock pattern may require that the substantially continuous head movement as the user moves along the path from the start location to the end location.

### II. Example Wearable Computing Devices

Systems and devices in which example embodiments may be implemented will now be described in greater detail. In general, an example system may be implemented in or may take the form of a wearable computer (also referred to as a wearable computing device). In an example embodiment, a wearable computer takes the form of or includes a head-mountable device (HMD).

It should be understood, however, that example systems may also be implemented in or take the form of other devices, such as a mobile phone, a tablet computer, or a personal computer, among other possibilities. Further, an example system may take the form of non-transitory computer readable medium, which has program instructions stored thereon that are executable by at a processor to provide the functionality described herein. An example system may also take the form of a device such as a wearable computer or mobile phone, or a subsystem of such a device, which includes a non-transitory computer readable medium having such program instructions stored thereon.

An HMD may generally be any display device that is capable of being worn on the head and, when worn, is configured to place a display in front of one or both eyes of the wearer. An HMD may take various forms such as a helmet or eyeglasses. As such, references to “eyeglasses” or a “glasses-style” HMD should be understood to refer to any HMD that has a glasses-like frame so that it can be worn on the head. Note, however, that a glasses-style HMD may or may not include a lens in front of one or both eyes. Further, example embodiments may be implemented by or in association with an HMD with a single display or with two displays, which may be referred to as a “monocular” HMD or a “binocular” HMD, respectively.

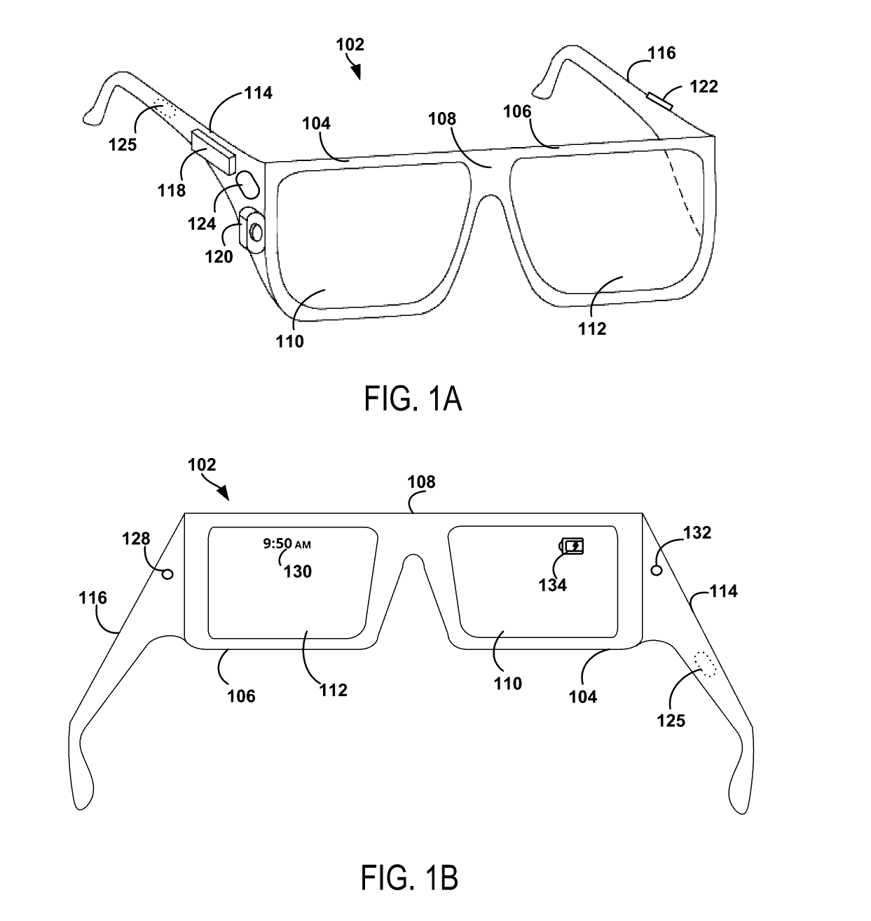

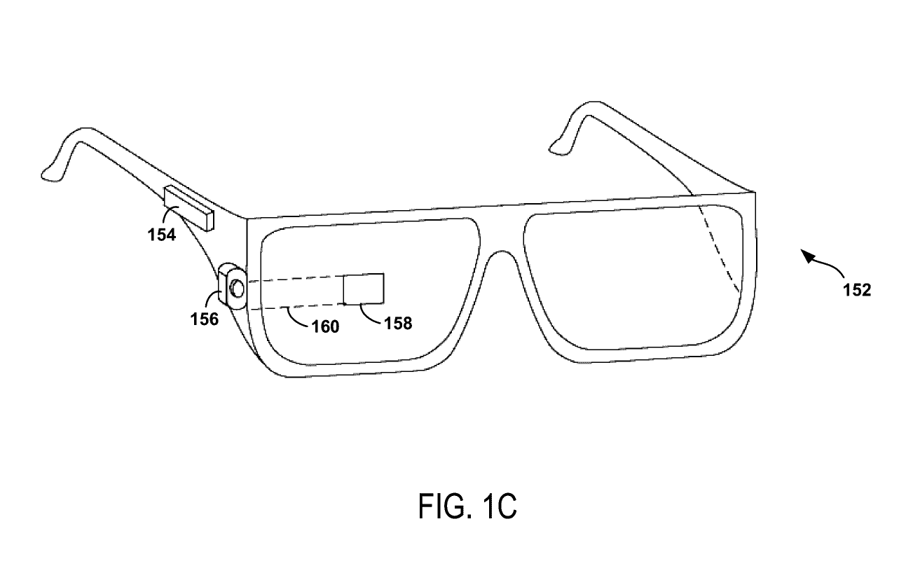

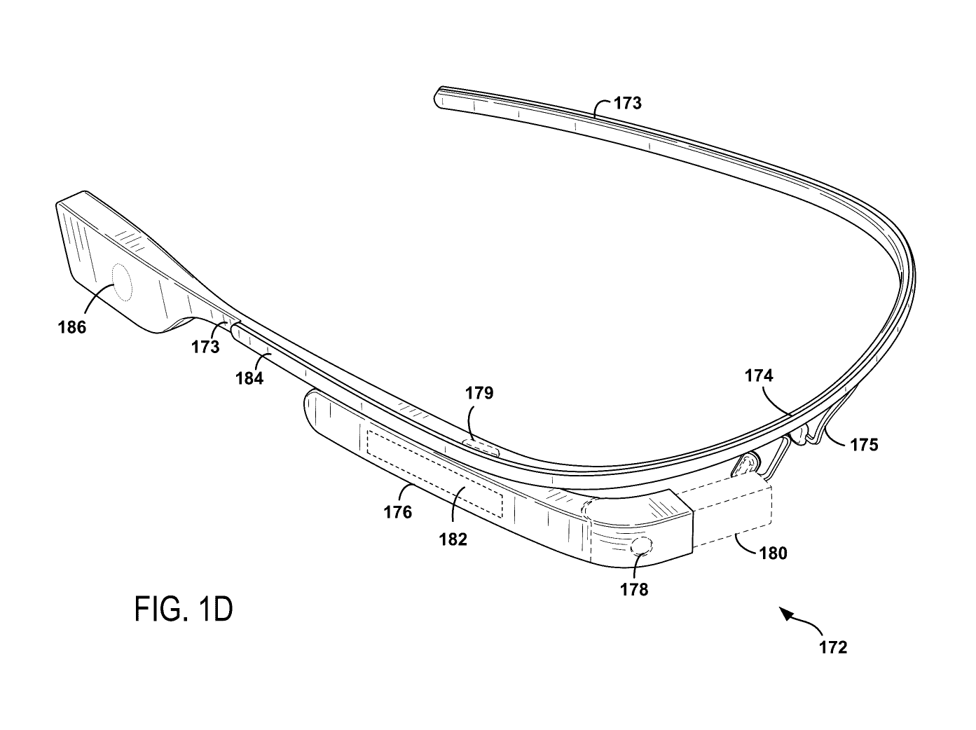

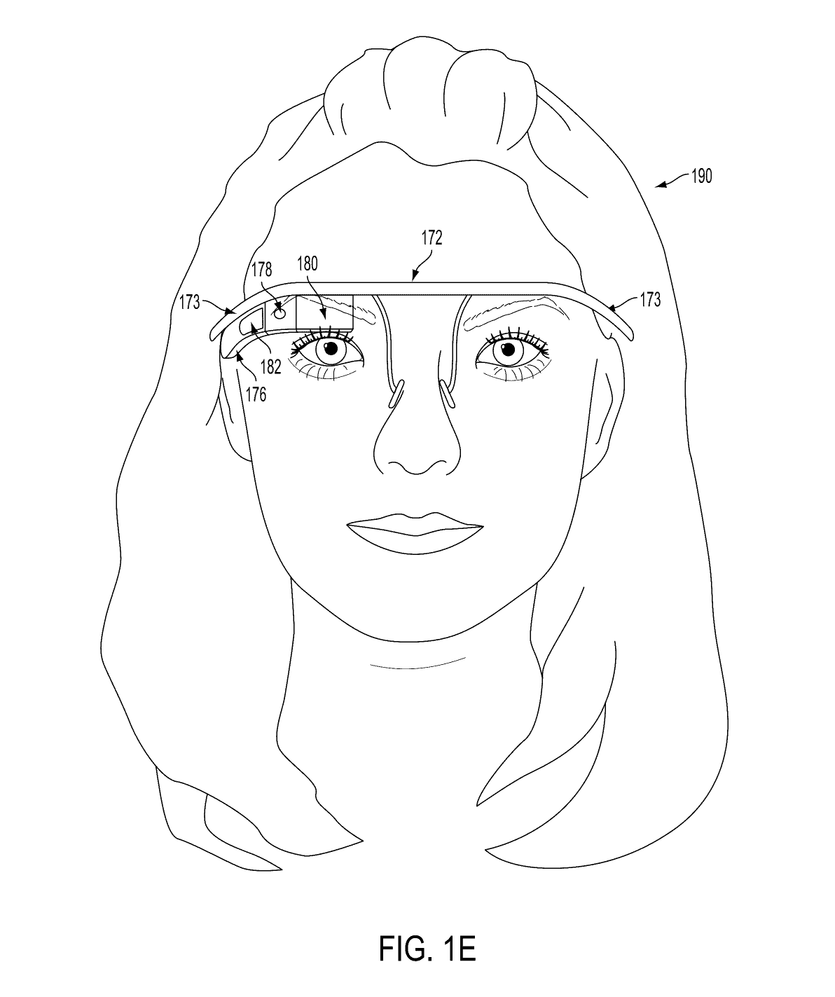

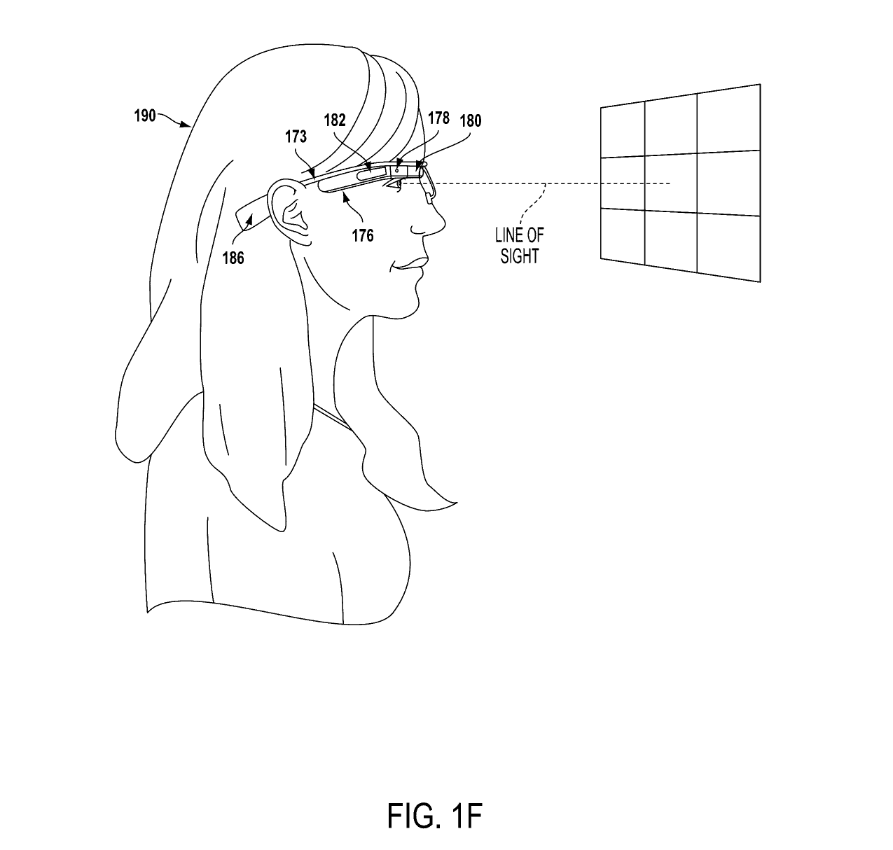

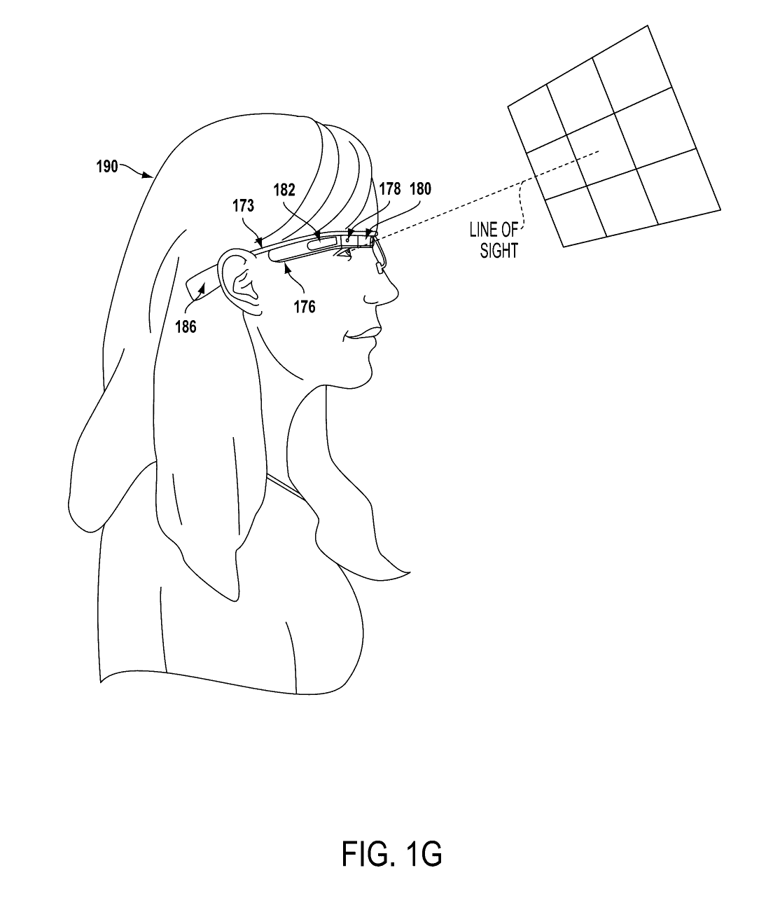

FIG. 1A illustrates a wearable computing system according to an example embodiment. In FIG. 1A, the wearable computing system takes the form of a head-mountable device (HMD) 102 (which may also be referred to as a head-mounted display). It should be understood, however, that example systems and devices may take the form of or be implemented within or in association with other types of devices, without departing from the scope of the invention. As illustrated in FIG. 1A, the HMD 102 includes frame elements including lens-frames 104, 106 and a center frame support 108, lens elements 110, 112, and extending side-arms 114, 116. The center frame support 108 and the extending side-arms 114, 116 are configured to secure the HMD 102 to a user's face via a user's nose and ears, respectively.

Each of the frame elements 104, 106, and 108 and the extending side-arms 114, 116 may be formed of a solid structure of plastic and/or metal, or may be formed of a hollow structure of similar material so as to allow wiring and component interconnects to be internally routed through the HMD 102. Other materials may be possible as well.

One or more of each of the lens elements 110, 112 may be formed of any material that can suitably display a projected image or graphic. Each of the lens elements 110, 112 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 114, 116 may each be projections that extend away from the lens-frames 104, 106, respectively, and may be positioned behind a user's ears to secure the HMD 102 to the user. The extending side-arms 114, 116 may further secure the HMD 102 to the user by extending around a rear portion of the user's head. Additionally or alternatively, for example, the HMD 102 may connect to or be affixed within a head-mounted helmet structure. Other configurations for an HMD are also possible.

The HMD 102 may also include an on-board computing system 118, an image capture device 120, a sensor 122, and a finger-operable touch pad 124. The on-board computing system 118 is shown to be positioned on the extending side-arm 114 of the HMD 102; however, the on-board computing system 118 may be provided on other parts of the HMD 102 or may be positioned remote from the HMD 102 (e.g., the on-board computing system 118 could be wire- or wirelessly-connected to the HMD 102). The on-board computing system 118 may include a processor and memory, for example. The on-board computing system 118 may be configured to receive and analyze data from the image capture device 120 and the finger-operable touch pad 124 (and possibly from other sensory devices, user interfaces, or both) and generate images for output by the lens elements 110 and 112.

The image capture device 120 may be, for example, a camera that is configured to capture still images and/or to capture video. In the illustrated configuration, image capture device 120 is positioned on the extending side-arm 114 of the HMD 102; however, the image capture device 120 may be provided on other parts of the HMD 102. The image capture device 120 may be configured to capture images at various resolutions or at different frame rates. Many image capture devices with a small form-factor, such as the cameras used in mobile phones or webcams, for example, may be incorporated into an example of the HMD 102.

Further, although FIG. 1A illustrates one image capture device 120, more image capture device may be used, and each may be configured to capture the same view, or to capture different views. For example, the image capture device 120 may be forward facing to capture at least a portion of the real-world view perceived by the user. This forward facing image captured by the image capture device 120 may then be used to generate an augmented reality where computer generated images appear to interact with or overlay the real-world view perceived by the user.

The sensor 122 is shown on the extending side-arm 116 of the HMD 102; however, the sensor 122 may be positioned on other parts of the HMD 102. For illustrative purposes, only one sensor 122 is shown. However, in an example embodiment, the HMD 102 may include multiple sensors. For example, an HMD 102 may include sensors 102 such as one or more gyroscopes, one or more accelerometers, one or more magnetometers, one or more light sensors, one or more infrared sensors, and/or one or more microphones. Other sensing devices may be included in addition or in the alternative to the sensors that are specifically identified herein.

The finger-operable touch pad 124 is shown on the extending side-arm 114 of the HMD 102. However, the finger-operable touch pad 124 may be positioned on other parts of the HMD 102. Also, more than one finger-operable touch pad may be present on the HMD 102. The finger-operable touch pad 124 may be used by a user to input commands. The finger-operable touch pad 124 may sense at least one of a pressure, position and/or a movement of one or more fingers via capacitive sensing, resistance sensing, or a surface acoustic wave process, among other possibilities. The finger-operable touch pad 124 may be capable of sensing movement of one or more fingers simultaneously, in addition to sensing movement in a direction parallel or planar to the pad surface, in a direction normal to the pad surface, or both, and may also be capable of sensing a level of pressure applied to the touch pad surface. In some embodiments, the finger-operable touch pad 124 may be formed of one or more translucent or transparent insulating layers and one or more translucent or transparent conducting layers. Edges of the finger-operable touch pad 124 may be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad may be operated independently, and may provide a different function.

In a further aspect, HMD 102 may be configured to receive user input in various ways, in addition or in the alternative to user input received via finger-operable touch pad 124. For example, on-board computing system 118 may implement a speech-to-text process and utilize a syntax that maps certain spoken commands to certain actions. In addition, HMD 102 may include one or more microphones via which a wearer's speech may be captured. Configured as such, HMD 102 may be operable to detect spoken commands and carry out various computing functions that correspond to the spoken commands.

As another example, HMD 102 may interpret certain head-movements as user input. For example, when HMD 102 is worn, HMD 102 may use one or more gyroscopes and/or one or more accelerometers to detect head movement. The HMD 102 may then interpret certain head-movements as being user input, such as nodding, or looking up, down, left, or right. An HMD 102 could also pan or scroll through graphics in a display according to movement. Other types of actions may also be mapped to head movement.

As yet another example, HMD 102 may interpret certain gestures (e.g., by a wearer's hand or hands) as user input. For example, HMD 102 may capture hand movements by analyzing image data from image capture device 120, and initiate actions that are defined as corresponding to certain hand movements.

As a further example, HMD 102 may interpret eye movement as user input. In particular, HMD 102 may include one or more inward-facing image capture devices and/or one or more other inward-facing sensors (not shown) that may be used to track eye movements and/or determine the direction of a wearer's gaze. As such, certain eye movements may be mapped to certain actions. For example, certain actions may be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 may be, for example, a vibration transducer or an electroacoustic transducer that produces sound in response to an electrical audio signal input. The frame of HMD 102 may be designed such that when a user wears HMD 102, the speaker 125 contacts the wearer. Alternatively, speaker 125 may be embedded within the frame of HMD 102 and positioned such that, when the HMD 102 is worn, speaker 125 vibrates a portion of the frame that contacts the wearer. In either case, HMD 102 may be configured to send an audio signal to speaker 125, so that vibration of the speaker may be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) may be implemented, depending upon the particular implementation. Generally, any component that is arranged to vibrate the HMD 102 may be incorporated as a vibration transducer. Yet further it should be understood that an HMD 102 may include a single speaker 125 or multiple speakers. In addition, the location(s) of speaker(s) on the HMD may vary, depending upon the implementation. For example, a speaker may be located proximate to a wearer's temple (as shown), behind the wearer's ear, proximate to the wearer's nose, and/or at any other location where the speaker 125 can vibrate the wearer's bone structure.

FIG. 1B illustrates an alternate view of the wearable computing device illustrated in FIG. 1A. As shown in FIG. 1B, the lens elements 110, 112 may act as display elements. The HMD 102 may include a first projector 128 coupled to an inside surface of the extending side-arm 116 and configured to project a display 130 onto an inside surface of the lens element 112. Additionally or alternatively, a second projector 132 may be coupled to an inside surface of the extending side-arm 114 and configured to project a display 134 onto an inside surface of the lens element 110.

The lens elements 110, 112 may act as a combiner in a light projection system and may include a coating that reflects the light projected onto them from the projectors 128, 132. In some embodiments, a reflective coating may not be used (e.g., when the projectors 128, 132 are scanning laser devices).

In alternative embodiments, other types of display elements may also be used. For example, the lens elements 110, 112 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of an HMD 152. The HMD 152 may include frame elements and side-arms such as those described with respect to FIGS. 1A and 1B. The HMD 152 may additionally include an on-board computing system 154 and an image capture device 156, such as those described with respect to FIGS. 1A and 1B. The image capture device 156 is shown mounted on a frame of the HMD 152. However, the image capture device 156 may be mounted at other positions as well.

As shown in FIG. 1C, the HMD 152 may include a single display 158 which may be coupled to the device. The display 158 may be formed on one of the lens elements of the HMD 152, such as a lens element described with respect to FIGS. 1A and 1B, and may be configured to overlay computer-generated graphics in the user's view of the physical world. The display 158 is shown to be provided in a center of a lens of the HMD 152, however, the display 158 may be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. The HMD 172 may include side-arms 173, a center frame support 174, and a bridge portion with nosepiece 175. In the example shown in FIG. 1D, the center frame support 174 connects the side-arms 173. The HMD 172 does not include lens-frames containing lens elements. The HMD 172 may additionally include a component housing 176, which may include an on-board computing system (not shown), an image capture device 178, and a button 179 for operating the image capture device 178 (and/or usable for other purposes). Component housing 176 may also include other electrical components and/or may be electrically connected to electrical components at other locations within or on the HMD. HMD 172 also includes a BCT 186.

The HMD 172 may include a single display 180, which may be coupled to one of the side-arms 173 via the component housing 176. In an example embodiment, the display 180 may be a see-through display, which is made of glass and/or another transparent or translucent material, such that the wearer can see their environment through the display 180. Further, the component housing 176 may include the light sources (not shown) for the display 180 and/or optical elements (not shown) to direct light from the light sources to the display 180. As such, display 180 may include optical features that direct light that is generated by such light sources towards the wearer's eye, when HMD 172 is being worn.

In a further aspect, HMD 172 may include a sliding feature 184, which may be used to adjust the length of the side-arms 173. Thus, sliding feature 184 may be used to adjust the fit of HMD 172. Further, an HMD may include other features that allow a wearer to adjust the fit of the HMD, without departing from the scope of the invention.

FIGS. 1E to 1G are simplified illustrations of the HMD 172 shown in FIG. 1D, being worn by a wearer 190. As shown in FIG. 1F, when HMD 172 is worn, BCT 186 is arranged such that when HMD 172 is worn, BCT 186 is located behind the wearer's ear. As such, BCT 186 is not visible from the perspective shown in FIG. 1E.

In the illustrated example, the display 180 may be arranged such that when HMD 172 is worn, display 180 is positioned in front of or proximate to a user's eye when the HMD 172 is worn by a user. For example, display 180 may be positioned below the center frame support and above the center of the wearer's eye, as shown in FIG. 1E. Further, in the illustrated configuration, display 180 may be offset from the center of the wearer's eye (e.g., so that the center of display 180 is positioned to the right and above of the center of the wearer's eye, from the wearer's perspective).

Configured as shown in FIGS. 1E to 1G, display 180 may be located in the periphery of the field of view of the wearer 190, when HMD 172 is worn. Thus, as shown by FIG. 1F, when the wearer 190 looks forward, the wearer 190 may see the display 180 with their peripheral vision. As a result, display 180 may be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 may view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

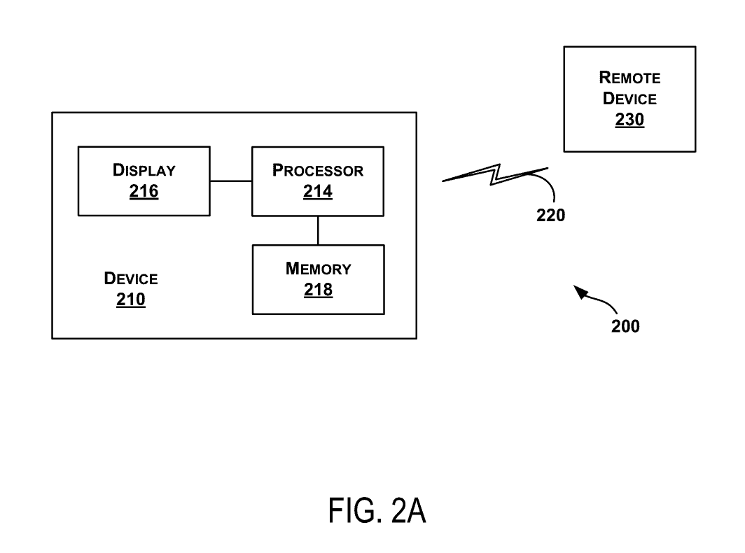

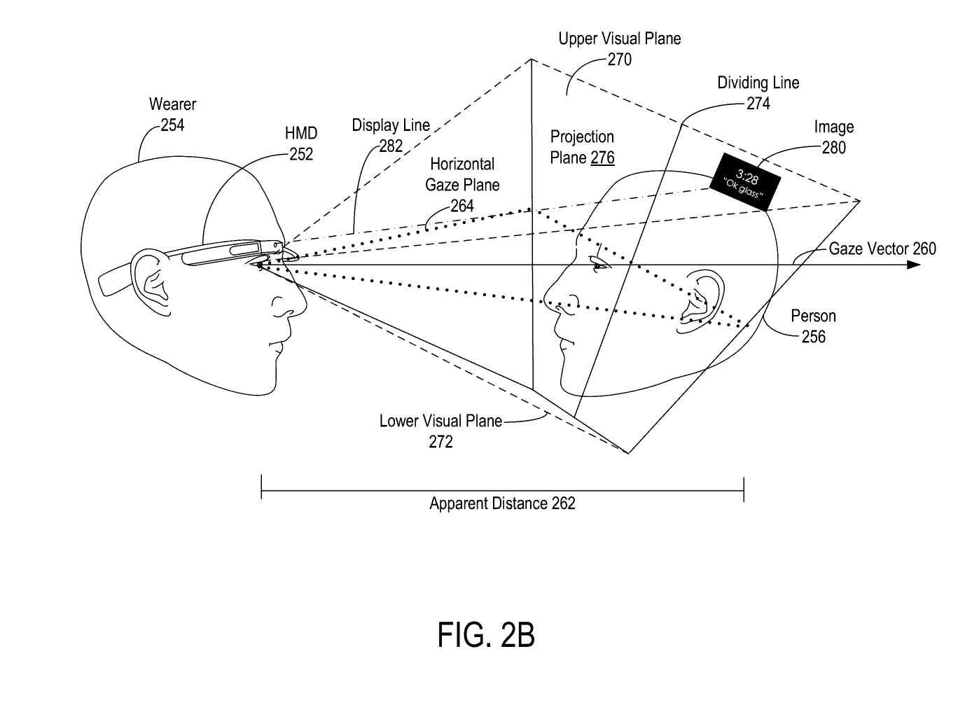

FIG. 2A is a simplified block diagram a computing device 210 according to an example embodiment. In an example embodiment, device 210 communicates using a communication link 220 (e.g., a wired or wireless connection) to a remote device 230. The device 210 may be any type of device that can receive data and display information corresponding to or associated with the data. For example, the device 210 may take the form of or include a head-mountable display, such as the head-mounted devices 102, 152, or 172 that are described with reference to FIGS. 1A to 1G.

The device 210 may include a processor 214 and a display 216. The display 216 may be, for example, an optical see-through display, an optical see-around display, or a video see-through display. The processor 214 may receive data from the remote device 230, and configure the data for display on the display 216. The processor 214 may be any type of processor, such as a micro-processor or a digital signal processor, for example.

The device 210 may further include on-board data storage, such as memory 218 coupled to the processor 214. The memory 218 may store software that can be accessed and executed by the processor 214, for example.

The remote device 230 may be any type of computing device or transmitter including a laptop computer, a mobile telephone, head-mountable display, tablet computing device, etc., that is configured to transmit data to the device 210. The remote device 230 and the device 210 may contain hardware to enable the communication link 220, such as processors, transmitters, receivers, antennas, etc.

Further, remote device 230 may take the form of or be implemented in a computing system that is in communication with and configured to perform functions on behalf of client device, such as computing device 210. Such a remote device 230 may receive data from another computing device 210 (e.g., an HMD 102, 152, or 172 or a mobile phone), perform certain processing functions on behalf of the device 210, and then send the resulting data back to device 210. This functionality may be referred to as “cloud” computing.

In FIG. 2A, the communication link 220 is illustrated as a wireless connection; however, wired connections may also be used. For example, the communication link 220 may be a wired serial bus such as a universal serial bus or a parallel bus. A wired connection may be a proprietary connection as well. The communication link 220 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 may be accessible via the Internet and may include a computing cluster associated with a particular web service (e.g., social-networking, photo sharing, address book, etc.).

FIG. 2B shows an example projection of UI elements described herein via an image 280 by an example head-mountable device (HMD) 252, according to an example embodiment. Other configurations of an HMD may be also be used to present the UI described herein via image 280. FIG. 2B shows wearer 254 of HMD 252 looking at an eye of person 256. As such, wearer 254′s gaze, or direction of viewing, is along gaze vector 260. A horizontal plane, such as horizontal gaze plane 264 can then be used to divide space into three portions: space above horizontal gaze plane 264, space in horizontal gaze plane 264, and space below horizontal gaze plane 264. In the context of projection plane 276, horizontal gaze plane 260 appears as a line that divides projection plane into a subplane above the line of horizontal gaze plane 260, a subplane a subspace below the line of horizontal gaze plane 260, and the line where horizontal gaze plane 260 intersects projection plane 276. In FIG. 2B, horizontal gaze plane 264 is shown using dotted lines.

Additionally, a dividing plane, indicated using dividing line 274 can be drawn to separate space into three other portions: space to the left of the dividing plane, space on the dividing plane, and space to right of the dividing plane. In the context of projection plane 276, the dividing plane intersects projection plane 276 at dividing line 274. Thus the dividing plane divides projection plane into: a subplane to the left of dividing line 274, a subplane to the right of dividing line 274, and dividing line 274. In FIG. 2B, dividing line 274 is shown as a solid line.

Humans, such wearer 254, when gazing in a gaze direction, may have limits on what objects can be seen above and below the gaze direction. FIG. 2B shows the upper visual plane 270 as the uppermost plane that wearer 254 can see while gazing along gaze vector 260, and shows lower visual plane 272 as the lowermost plane that wearer 254 can see while gazing along gaze vector 260. In FIG. 2B, upper visual plane 270 and lower visual plane 272 are shown using dashed lines.

The HMD can project an image for view by wearer 254 at some apparent distance 262 along display line 282, which is shown as a dotted and dashed line in FIG. 2B. For example, apparent distance 262 can be 1 meter, four feet, infinity, or some other distance. That is, HMD 252 can generate a display, such as image 280, which appears to be at the apparent distance 262 from the eye of wearer 254 and in projection plane 276. In this example, image 280 is shown between horizontal gaze plane 264 and upper visual plane 270; that is image 280 is projected above gaze vector 260. In this example, image 280 is also projected to the right of dividing line 274. As image 280 is projected above and to the right of gaze vector 260, wearer 254 can look at person 256 without image 280 obscuring their general view. In one example, the display element of the HMD 252 is translucent when not active (i.e. when image 280 is not being displayed), and so the wearer 254 can perceive objects in the real world along the vector of display line 282.

Other example locations for displaying image 280 can be used to permit wearer 254 to look along gaze vector 260 without obscuring the view of objects along the gaze vector. For example, in some embodiments, image 280 can be projected above horizontal gaze plane 264 near and/or just above upper visual plane 270 to keep image 280 from obscuring most of wearer 254′s view. Then, when wearer 254 wants to view image 280, wearer 254 can move their eyes such that their gaze is directly toward image 280.

### III. Example Methods

### A. Unlocking Based on a Sequence of Image Locations

As noted above, a predetermined unlock pattern may correspond to a sequence of two or more locations in the image. In such an embodiment, the HMD's user may use head movement to move a graphic icon (and thus a corresponding input region) with respect to the image, and input particular locations in the image by, e.g., tapping a touchpad when the input region is over each particular location.

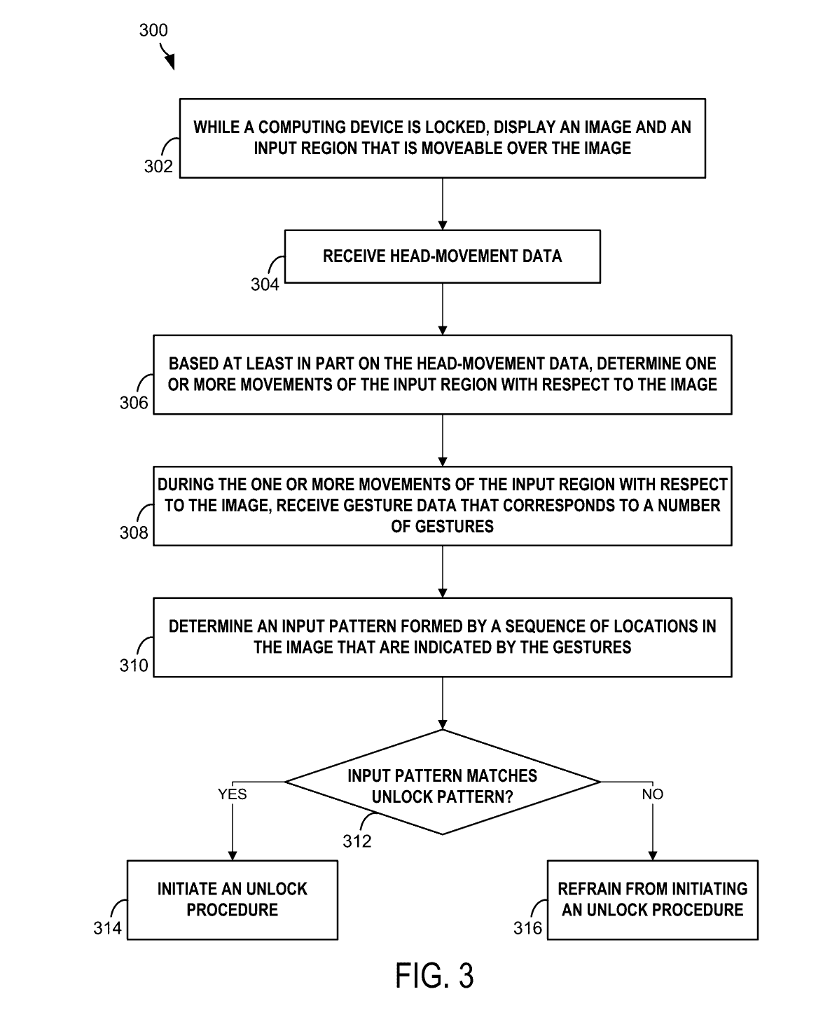

FIG. 3 is a flow chart illustrating a method 300, according to an example embodiment. In particular, method 300 may be implemented to help provide an unlock screen via which a user can enter an unlock pattern by sequentially identifying predetermined locations in the image that form the user's unlock pattern.

More specifically, while a computing device is locked, the computing device may display an image and an input region that is moveable over the image, as shown by block 302. The computing device may then receive head-movement data, which is indicative of head movement, as shown by block 304. Based at least in part on the head-movement data, the computing device may determine one or more movements of the input region with respect to the image, as shown by block 306. Further, during the one or more movements of the input region with respect to the image, the computing device may receive gesture data that corresponds to a number of gestures, as shown by block 308. Further, the computing device may determine an input pattern formed by a sequence of locations in the image that are indicated by the gestures, as shown by block 310. In an example embodiment, each gesture indicates the location of the input region in the image at or near the time the gesture was made.

In order to determine whether to unlock, the computing device may determine whether or not the input pattern matches a predetermined unlock pattern, as shown by block 312. In an example embodiment, the unlock pattern may be a predetermined sequence of two or more locations in the image. If the input pattern matches the predetermined unlock pattern, then the computing device initiates an unlock procedure, as shown by block 314. And, if the input pattern does not match the predetermined unlock pattern, then the computing device refrains from initiating the unlock procedure, as shown by block 316.

The gesture data may correspond to various types of gestures, which may be detected via various types of interfaces. In an example embodiment, the gesture data may correspond to gestures on a touch-based interface, such as taps and/or swipes on a touchpad or touchscreen. For instance, at block 308, an HMD such as HMD 172 of FIG. 1D, may detect taps on a side-mounted touch pad 182. Accordingly, a user that is wearing HMD 172 may input an unlock pattern by using head movements to move the input region to the image locations in the unlock pattern, and tapping the side-mounted touch pad 182 as the input region moves over each image location in the pattern.

In other embodiments, the gesture data may correspond to hand gestures made in the air. Such hand gestures may be detected by a camera and/or by proximity sensor(s), for example. In such an embodiment, the user may input the unlock pattern by performing a certain hand movement each time the input region moves over an image location in the unlock pattern.

In yet other embodiments, the gesture data may correspond to eye gestures such as winks and/or certain directional eye movements. In such an embodiment, the eye gestures may be detected by an eye- or gaze-tracking system of an HMD. For example, the user may input the unlock pattern by blinking each time the input region moves over an image location in the unlock pattern. Other examples are possible.

In yet other embodiments, the gesture data may correspond to input actions on a mechanical interface, such as a mouse, keyboard, or button on an HMD, among other possibilities. For example, the user may input the unlock pattern by pressing a button on the HMD, on a keyboard, or on mouse each time the input region moves over an image location in the unlock pattern. Other examples are possible.

In some embodiments, at block 312, the function of determining whether or not the input pattern matches the predetermined unlock pattern may be performed on-the-fly, as each image location in the input pattern is detected. For example, each time a new image location is input via a gesture, the computing device may compare the newly-identified image location to the next image location in the sequence making up the unlock pattern. If the newly-inputted image location matches the next image location in the unlock pattern, then the computing device may continue the unlock process and wait for the next image location (or, if the newly-inputted image location is the last image location in the sequence making up the unlock pattern, the computing device may determine that the unlock pattern is correct and responsively unlock).

On the other hand, if a newly-inputted image location does not match the next image location in the unlock pattern, then the computing device may reset the unlock process, and indicate to the user that there is been an error. Alternatively, when a newly-inputted image location does not match the next image location in the unlock pattern, the computing device may indicate this to the user and allow the user one or more additional attempts to enter the next image location correctly. Further, the computing device may limit the number of additional attempts that can be made to input a given image location in the unlock pattern, and/or may limit the number of total additional attempts to input image locations that can be made during the entire process of inputting the unlock pattern.

In other embodiments, the computing device may not compare image locations as they are received. Instead, at block 312, the computing device may wait until the input pattern is completely entered (e.g., until the number received for the input pattern is the same as the number in the unlock sequence), and then determine whether the input pattern matches the predetermined unlock pattern.

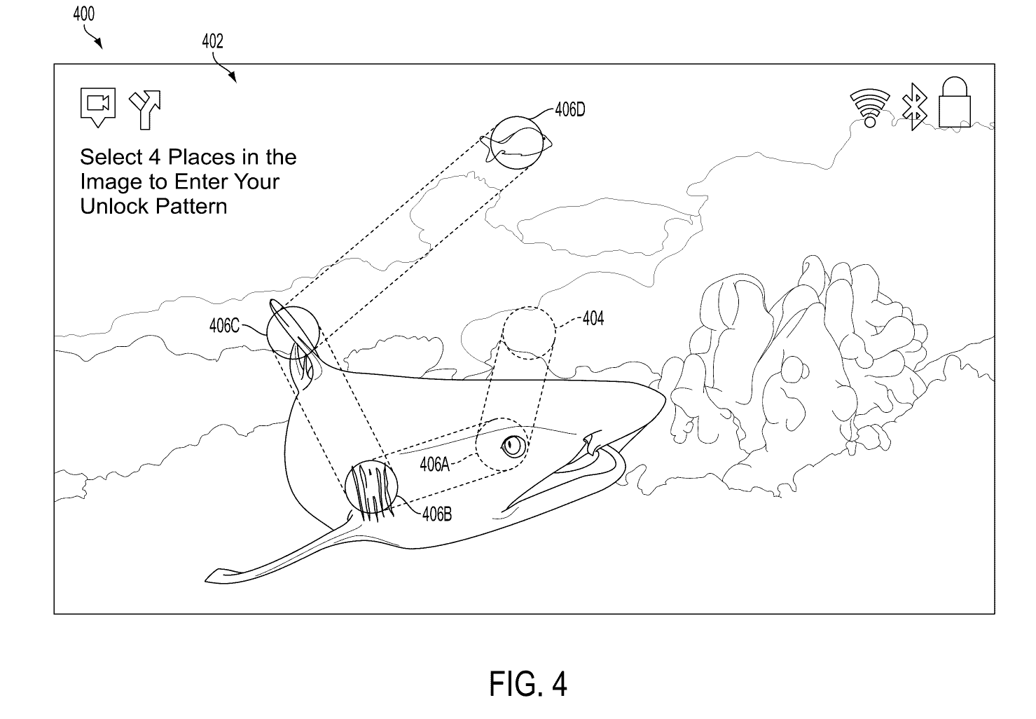

FIG. 4 is an illustration of a lock-screen 400, according to an example embodiment. More specifically, FIG. 4 shows a lock-screen 400 on which a user has entered an input pattern by sequentially indicating predetermined locations in an image 402, which may be verified as matching a predetermined unlock pattern using an example method 300. The lock-screen 400 is described below by way of example as being displayed by an HMD. However, lock-screen 400 and others described herein may be implemented by other types of computing devices, without departing from the scope of the invention.

As shown, an image 402 of a shark is displayed on lock-screen 400. When the HMD displays the lock screen, the HMD may initially display a graphic representation of an input region 404 in the center of the image (at a location that may or may not be part of the predetermined unlock pattern). The HMD may then move the input region 404 with respect to the image 402 based on the wearer's head movements. More specifically, HMD may move the input region 404 based on movement of HMD, as indicated by sensors on the HMD such as accelerometer(s), gyroscope(s), and/or magnetometer(s), which is considered to be indicative of head movement of the HMD wearer.

In this example, the unlock pattern may be defined as a sequence of locations 406A to 406D in the image 402 of the shark. Accordingly, to input an unlock pattern and unlock the HMD, the user moves the input region along a path 408 that includes locations 406A to 406D. Further, to identify each locations 406A to 406D, the user may tap a touch-based interface (e.g., touchpad 182 of HMD 172) when the input region 404 is aligned with the respective location 406A to 406D.

Accordingly, while the HMD is moving the input region 404 according to head movement, the HMD may build up an input pattern of the locations indicated by the input region 404 when the user taps a touch-based interface. For example, if the user first taps the touch-based interface when the input region 404 is at location 406A, secondly taps again when the input region 404 is at location 406B, thirdly taps again when the input region 404 is at location 406C, and lastly taps when the input region 404 is at location 406D, then the HMD may determine that the input pattern of locations 406A, 406B, 406C, and 406D matches the predetermined unlock pattern, and responsively unlock.

Note that in some embodiments, the unlock pattern may be path independent. That is, the HMD may ignore how the input region 404 is moved about over the image, so long as the locations 406A to 406D are entered in the correct order. In other embodiments, however, the unlock pattern may be path dependent. In such an embodiment, the HMD may require that the input region 404 be moved between consecutive locations in the predetermined unlock pattern in a substantially straight line, or without deviating too much from a direct path between the locations. Note that in such embodiments, the tolerance for deviation from a specified path between two consecutive locations in the unlock pattern may vary according to the particular implementation.

In some embodiments, the image locations in the unlock pattern may correspond to certain features in the image, such that it may be easier for a user to remember the unlock pattern. The features that define an unlock pattern may accordingly be selected by the user. For instance, an HMD might allow a user to provide one of the user's own images or use a stock image for the lock screen. The HMD may then provide a setup interface via which the user can identify features (and possibly an order of the features in the image) that define an unlock pattern for the HMD.

For instance, a user may have provided the image 402 of the shark shown in FIG. 4 via such a setup interface. Further, the user may have indicated that the sequences of features for the unlock pattern by, e.g., selecting the shark's eye (at location 406A), then selecting the shark's gills (at location 406B), then selecting the shark's fin (at location 406C), and lastly selecting the fish above the shark (at location 406D). The setup interface may allow the user to select features that define the unlock pattern using similar input as used to input the unlock pattern and unlock the device (e.g., head movement to move an input region to specific features, and gestures to indicate when the input region is over a feature to be included in the unlock pattern).

Note that while the illustrated unlock pattern entered via lock-screen 400 is a predetermined sequence of four image locations, the number of image locations in the unlock pattern may vary, depending upon the particular implementation.

Further, in some embodiments, a computing device may visually present movement of the input region with respect to the image by moving the image in the display, while keeping the input region at the same location in the display (e.g., in the center of the display). For instance, an HMD's display may effectively function as a viewing window to a portion of the image, and the HMD may move the viewing window based on the head movement.

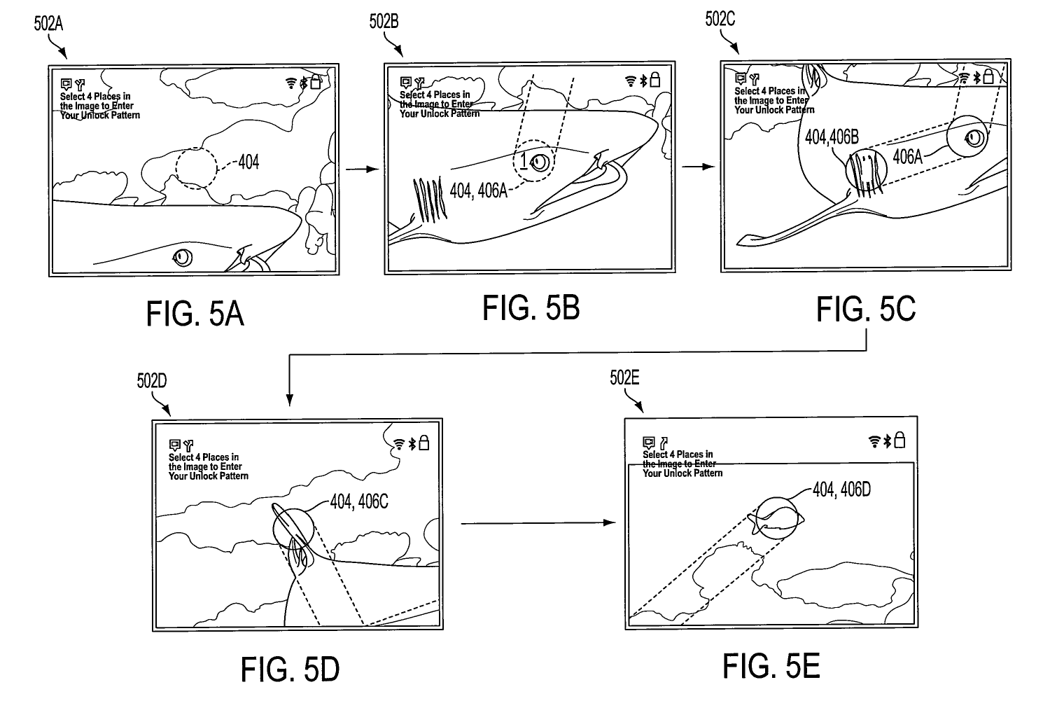

As a specific example, FIGS. 5A to 5E illustrate a sequence of screenshots 502A to 502E of an HMD's display, as a user enters the unlock pattern that was shown in FIG. 4. More specifically, the HMD may initially display a portion of the image such that the center of the image aligns with the input region 404, which is displayed in the center of the display, as shown in screenshot 502A.

As the HMD detects head movement, the HMD may move the image with respect to the display, while keeping the input region 404 centered in the display. In particular, the HMD may detect head movement downward and to the left and responsively move the image upwards and to the right in the display, as shown by the change in position of the image between screenshot 502A and 502B. Then, when the input region 404 is located at location 406A, as shown in screenshot 502B, the user may tap the HMD's touchpad to indicate that location 406A is the first location in the unlock sequence.

The HMD may then detect further head movement downward and to the left, and responsively move the image further upwards and to the right in the display, as shown by the change in position of the image between screenshot 502B and 502C. Then, when the input region 404 is located at location 406B, as shown in screenshot 502C, the user may tap the HMD's touchpad to indicate that location 406B is the second location in the unlock sequence.

The HMD may then detect head movement upward and further to the left, and responsively move the image downwards and to the right in the display, as shown by the change in position of the image between screenshot 502C and 502D. Then, when the input region 404 is located at location 406C, as shown in screenshot 502D, the user may tap the HMD's touchpad to indicate that location 406C is the third location in the unlock sequence.

The HMD may then detect head movement upward and back to the right, and responsively move the image downwards and to the left in the display, as shown by the change in position of the image between screenshot 502D and 502E. Then, when the input region 404 is located at location 406D, as shown in screenshot 502E, the user may tap the HMD's touchpad to indicate that location 406D is the fourth location in the unlock sequence. At this point, the HMD may verify that the unlock pattern has been entered correctly, and responsively unlock.

### B. Unlocking Based on a Sequence of Image Locations and Image Paths

In some embodiments, the predetermined unlock pattern may be defined as a sequence that includes both: (a) one or more locations in the image and (b) one or more paths in the image. The user may input particular locations in the image in the same way as described above; e.g., by moving an input region via head movement and tapping a touchpad or using another type of gesture to indicate when the input region is over a location that is part of the unlock pattern. To input a particular path in the image, the user may execute a different type of gesture, such as a tap-and-hold gesture on a touchpad. More specifically, the user can move their head while holding their finger down on the touchpad in order to input the path of the input region over the image during the time their finger is continuously touching the touchpad.

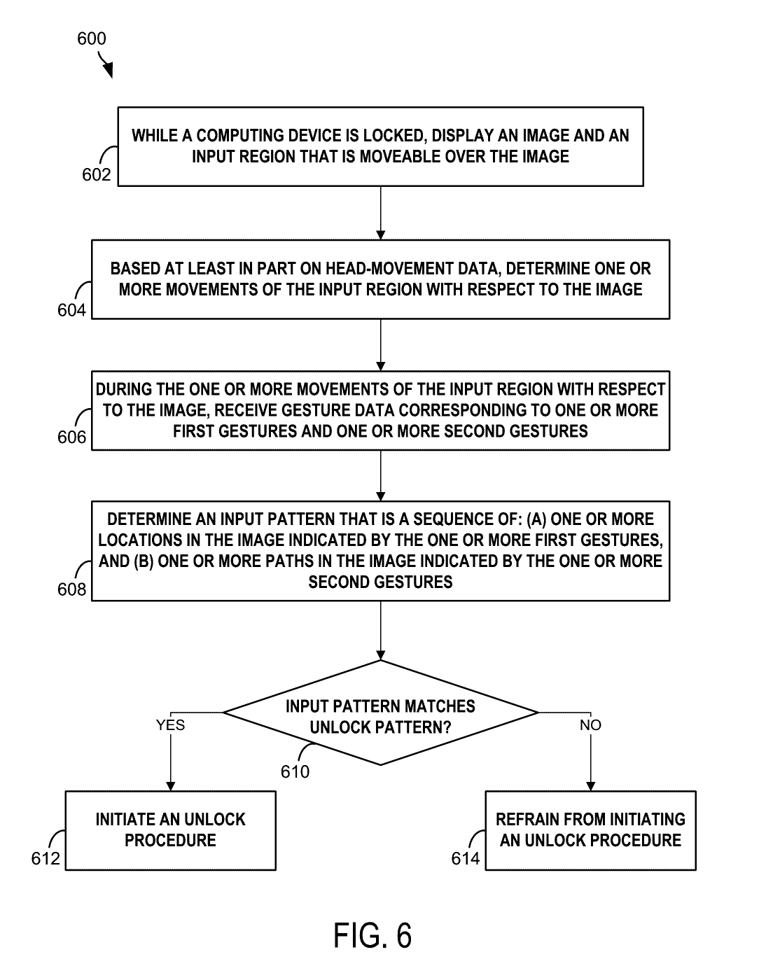

FIG. 6 is a flow chart illustrating a method 600, according to an example embodiment. In particular, method 600 may be implemented to help provide an unlock screen via which a user can enter an unlock pattern by inputting a sequence that includes both predetermined locations and predetermined paths in the image.

As shown by block 602, while a computing device is locked, the computing device may display an image and an input region that is moveable over the image. Based at least in part on head-movement data, the computing device may determine one or more movements of the input region with respect to the image, as shown by block 604. Further, during the one or more movements of the input region with respect to the image, the computing device may receive gesture data corresponding to one or more first gestures and one or more second gestures, as shown by block 606. The computing device may then determine an input pattern, which is a sequence of: (a) one or more locations in the image indicated by the one or more first gestures, and (b) one or more paths in the image indicated by the one or more second gestures, as shown by block 608. In an example embodiment, the one or more paths each correspond to movement of input region with respect to the image during one of the one or more second gestures.

The computing device may then determine whether or not the input pattern matches a predetermined unlock pattern, where the predetermined unlock pattern is a predetermined sequence of at least one location in the image and at least one path in the image, as shown by block 610. If the input pattern matches the predetermined unlock sequence, then the computing device initiates an unlock procedure, as shown by block 612. On the other hand, if the input pattern does not match the predetermined unlock sequence, then the computing device refrains from initiating an unlock procedure, as shown by block 614.

In an example embodiment, the first and second gestures, which indicate image location(s) and image path(s), respectively, may be different types of gestures. In an exemplary embodiment, the first and second gestures may be different touch gestures on a touch-based interface.

For example, to input a given image location as part of the input pattern, a user may use head movement to move the input region is over the image location, and then tap an HMD's touchpad. Further, to input a given image path as part of the input pattern, the user may use head movement to move the input region to a starting location of the path, then touch and hold their finger to the HMD's touchpad while moving their head such that input region moves along a desired path through the image. Then, when the input region reaches a desired ending image location, the user may lift their finger from the HMD's touchpad. When the user lifts their finger, the HMD may responsively add the path to the sequence of image locations and image paths making up the input pattern.

The gesture of tapping, holding, and lifting a finger from a touch-based interface, which may be used to input the path of the input region, may be referred to as a “tap-and-hold” gesture. Thus, in method 600, the one or more second gestures detected in the input data may be one or more tap-and-hold gestures. However, the one or more second gestures may take other forms, and/or may be detected via other types of interfaces (e.g., via sensors to detect hand gestures in the air, an eye-tracking system, or a mechanical user-interface). Generally, a second gesture may be any type of gesture with distinct components to indicate both when the input region begins defining the image path (e.g., when the user first touches a touchpad during a tap-and-hold gesture) and when the image path is complete (e.g., when the user lifts their finger from the touchpad at the end of a tap-and-hold gesture).

Note that the order of image locations and image paths may vary between different unlock patterns. Some unlock patterns may begin with a particular image location, while others may begin with a particular image path. Further, the order of subsequent image locations and image paths may vary as well. Further, the number of image paths and/or the number of image locations in the sequence may vary between different unlock patterns.

In some embodiments, at block 610, the function of determining whether or not the input pattern matches a predetermined unlock pattern may be performed on-the-fly, as each image location and/or image path in the input pattern is received. For example, each time a new image location or image path is inputted via the lock-screen, the computing device may compare the newly-inputted location or path to the next location or path in the sequence making up the unlock pattern. If the newly-inputted location or path matches the next location or path in the unlock pattern, then the computing device may continue the unlock process and wait for the next image location or path (or, if the newly-inputted location or path is the last image location in the sequence making up the unlock pattern, the computing device may determine that the unlock pattern is correct and responsively unlock).

On the other hand, if the newly-inputted location or path does not match the next location in the unlock pattern, then the computing device may reset the unlock process, and indicate to the user that there is been an error. Alternatively, when a newly-inputted location or path does not match the next location or path in the unlock pattern, the computing device may indicate this to the user and allow the user to one or more additional attempts to enter the next location or path correctly. Further, the computing device may limit the number of additional attempts that can be made to input a given location or path in the unlock pattern, and/or may limit the number of total additional attempts to input a location or path that can be made during the entire process of inputting the unlock pattern.

In other embodiments, the computing device may not compare image locations and paths as they are received. Instead, at block 610, the computing device may wait until the input pattern is completely entered, and then determine whether the input pattern matches the predetermined unlock pattern.

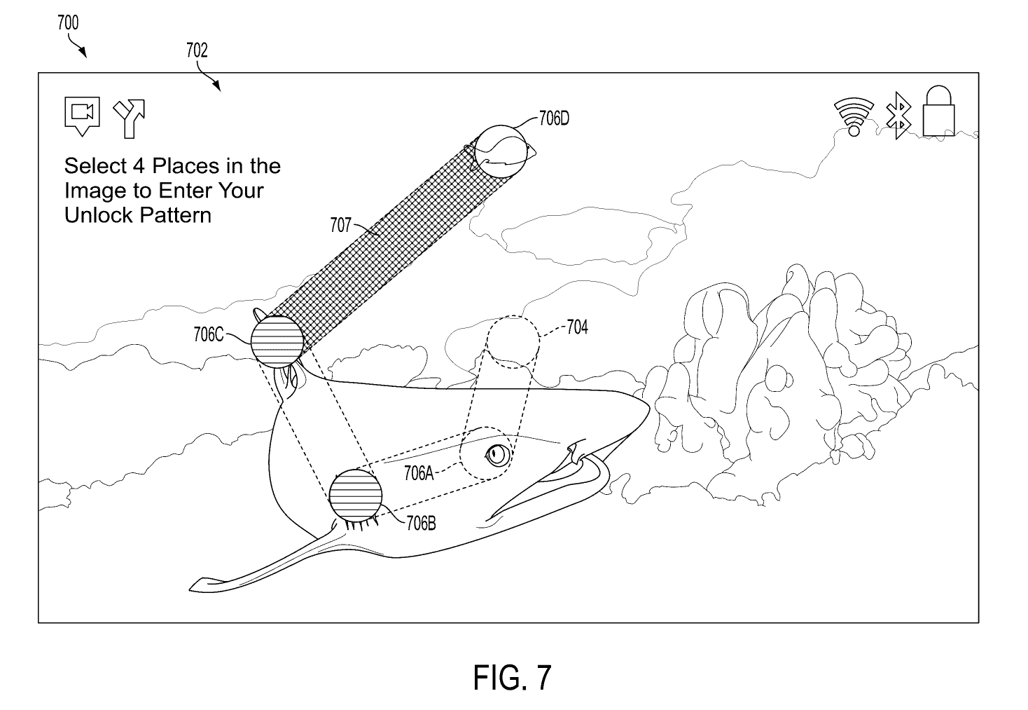

FIG. 7 is an illustration of another lock-screen 700, according to an example embodiment. More specifically, FIG. 7 shows a lock-screen 700 via which a user has entered an input pattern by sequentially indicating locations and paths in an image 702. This input pattern may be verified as a predetermined unlock pattern using example method 600.

More specifically, lock-screen 700 may be displayed by a computing device for which the unlock pattern has been defined as a sequence that includes image locations 706A and 706B in the image, and a path 707 between image locations 706C and 706D in the image 702 of the shark. When the HMD initially displays the image 702, the input region 704 may be located in the center of the image. The HMD may then move the input region 704 with respect to the image 702 according to the wearer's head movements.

As such, the user may unlock the HMD by moving the input region 704 over location 706A and tapping the HMD's touchpad, then moving the input region 704 over location 706B and tapping the touchpad, and then performing a tap-and-hold gesture while using head movement to move the input region 704 along a path between locations 706C and 706D (e.g., initially touching a touchpad when the input region is at location 706C, holding, and then lifting when the input region is at location 706D).

Further, as shown in FIG. 7, the input pattern may be visualized in the HMD's display as it is being by inputted by the user. In particular, the HMD may display dots at the image locations where the user taps (e.g., at locations 706A and 706B), and a line to represent each path that is input by the user (e.g., a line between locations 706C and 706D).

In some embodiments the HMD may display, e.g., a trail that shows the entire path of the input region, including portions of the path that are not part of the inputted image path. In such an embodiment, the HMD may visually distinguish the image location(s) and image path(s) that are inputted by, e.g., displaying a solid dot where an image location is inputted, displaying a solid line (which may be straight or curved) where an image path is inputted, and displaying a translucent line over the rest of the input region's path. In other embodiments, the HMD may display the image location(s) and image path(s) that have been input as part of the input pattern, without visualizing the rest of the input region's path.

### C. Unlocking Based on a Multi-Segment Image Path

In some embodiments, the unlock pattern may be defined as a path through a sequence of three or more image locations. For instance, the unlock pattern may be path through an image that is defined by a start location, one or more intermediary locations, and an end location. To enter such an unlock pattern, the user may use head movements to move the input region to the start location and then tap a touch-based interface to input the starting location. The user may then use head movements to move the input region along a path that in the image that includes one or more intermediary locations (without holding their finger on the touchpad). Then, when the input region reaches the end location, the user may tap the touch-based interface to input the end location and indicate that the input pattern is complete.

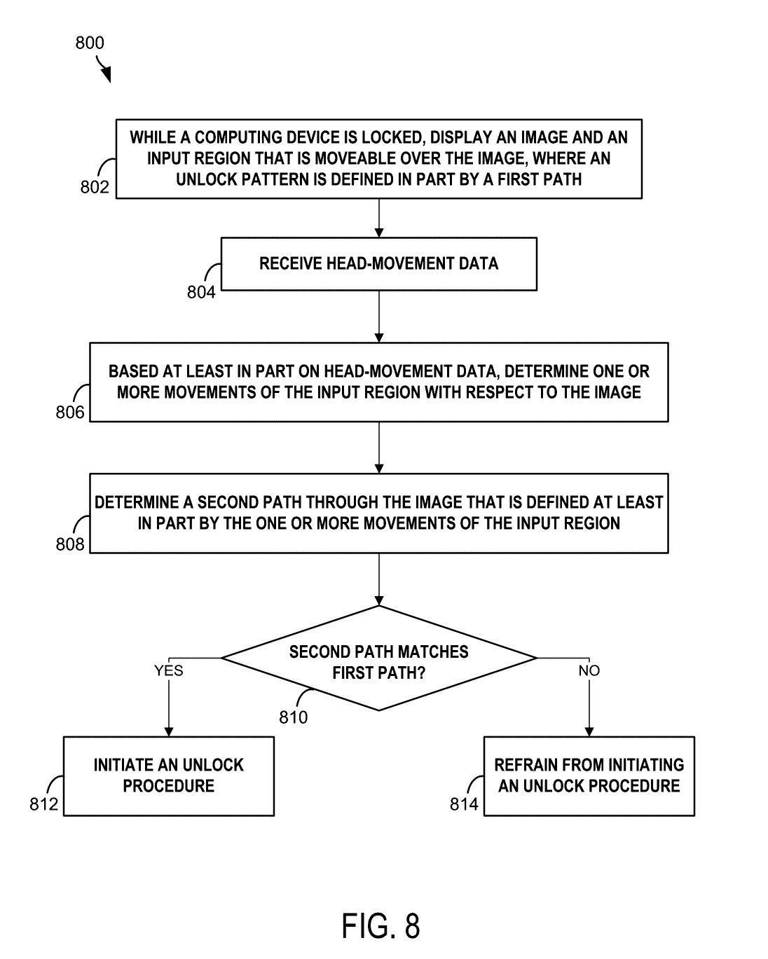

FIG. 8 is a flow chart illustrating a method 800, according to an example embodiment. In particular, method 800 may be implemented to help provide an unlock screen via which a user can enter an unlock pattern by inputting a path through a predetermined sequence of three or more locations in the image. Accordingly, method 800 may help to verify an unlock pattern, when the unlock pattern is a first path through the image, which is defined at least in part by a predetermined sequence of three or more locations in a displayed image.

More specifically, while a computing device is locked, the computing device may display an image and an input region that is moveable over the image, as shown by block 802. While the displaying the image and the input region, the computing device may receive head-movement data that is indicative of head movement, as shown by block 804. Based at least in part on the head-movement data, the computing device may determine one or more movements of the input region with respect to the image, as shown by block 806. Further, the computing device may determine a second path through the image that is defined at least in part by the one or more movements of the input region, as shown by block 808.

The computing device may then determine whether or not the second path matches the first path, as shown by block 810. This determination may be based at least in part on a determination as to whether or not the second path passed through the predetermined sequence of the three or more image locations that define the first path. If the second path matches the first path, then initiating an unlock procedure, as shown by block 812. On the other hand, if the second path does not match the first path, then refraining from initiating an unlock procedure, as shown by block 814.

An example embodiment may allow a user to indicate a path through an image by using head movement to move the input region through an image path defined by a sequence that includes a start location, one or more intermediary locations, and an end location. Further, the user may indicate the start and end location with gestures performed when the input region is located over the start and end location, respectively.

Thus, at block 808, the function of determining of the second path through the image may involve the computing device detecting a first gesture and responsively determining the start location of the second path based on the location of the input region at or near the time of the first gesture. In particular, the computing device may set the start location to be the location of the input region when the data indicating the first gesture is received. Further, at block 808, the computing device may detecting a second gesture, which is subsequent to the first gesture, and responsively determine an end location of the second path based on the location of the input region at or near the time of the second gesture. In particular, the computing device may set the end location to be the location of the input region when the data indicating the second gesture is received. The second path may thus be determined to be the path of the input region as the input region moved from the start location to the end location in the image.

As noted, the function of determining whether or not the second path matches the first path, at block 810, may involve the computing determining whether or not the second path includes the predetermined sequence of the three or more locations in the image. Various techniques may be used to determine whether a matching path has been entered.

In some embodiments, second path may be considered to match the first path based solely on the determination that the second path passes through the sequence of the three or more image locations that at least in part define the first path. If the second path includes the predetermined sequence of the three or more image locations, then the computing device may determine that the second path matches the first path, and responsively unlock. However, if the second path does not include at least one location from the predetermined sequence of the three or more locations in the image, then the computing device may determine that the second path does not match the first path, and remain locked.

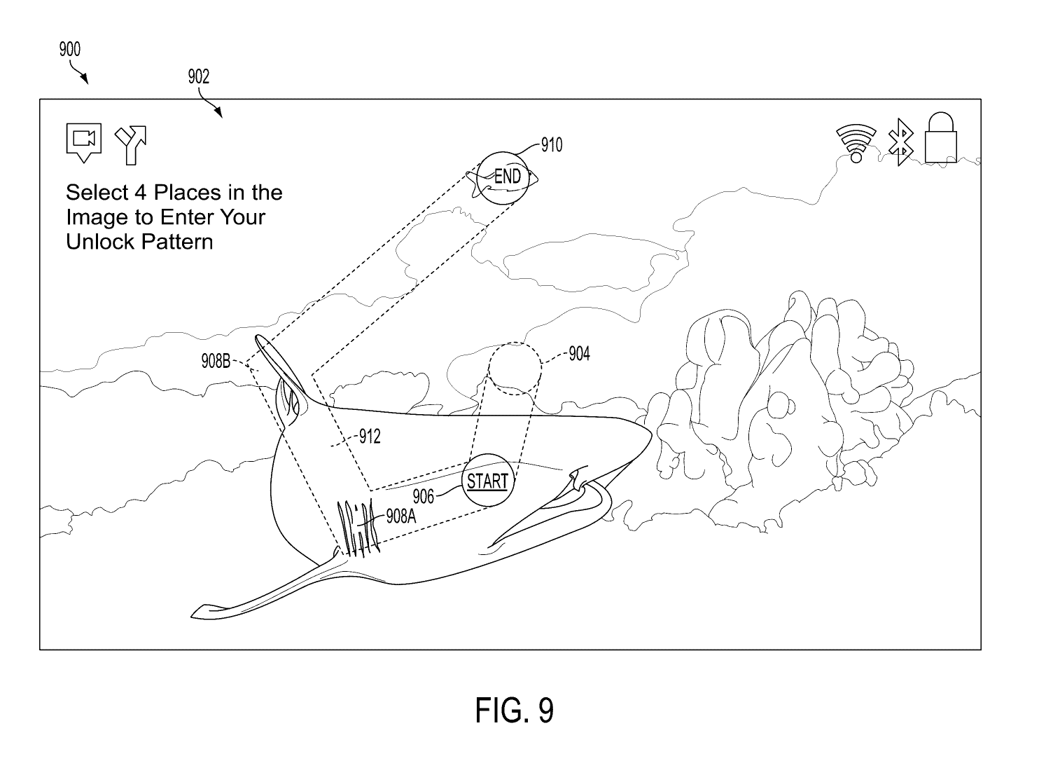

For example, FIG. 9 is an illustration of another lock-screen 900, according to an example embodiment. As shown, lock-screen 900 includes an image 902, and may further include an input region 904, which is initially displayed over the center of image as shown. Now consider the scenario where the unlock pattern is a path that is defined at least in part by the sequence of a start location 906, followed by two intermediary locations 908A and 908B, followed by an end location 910. In this scenario, the computing device may consider the unlock pattern to have been correctly entered when the user: (i) taps the touchpad when the input region is over the start location 906, then (ii) uses head movement to move the input region on a path 912 that includes the two intermediary locations 908A and 908B, in the correct order, and then (iii) taps the touchpad when the input region is over the end location 910.

In other embodiments, a computing device may also consider the fit of the second path to the first path when determining if the unlock pattern has been correctly entered. In particular, the computing device may look at characteristics of the paths such as direction, curvature, and/or shape to determine how close the second path is to replicating the first path. In view of one or more of such characteristics, the computing device may allow for some threshold amount of deviation from the first path, beyond which the second path will not be considered a match. The threshold amount of deviation from the first path may vary, depending upon the particular implementation.

In a further aspect, some embodiments may require substantially continuous movement of the input region through the second path (and thus require the substantially continuous head movement when inputting the path). In such an embodiment, if the user stops moving their head, or the movement drops bellows some threshold speed, for a predetermined period of time, then the computing device may reset the analysis of the input pattern and require that the user start over by moving the input region to the start location in the image, and then tapping the touchpad while the input region is over the start location.

### IV. Additional Aspects

In some embodiments, when an attempt to input an unlock pattern is determined to have failed (e.g., when an input pattern does not match the predetermined unlock pattern), a computing device may reset the lock-screen and allow one or more additional attempts to input the unlock pattern. Further, a computing device may implement a process that provides additional security in the event of multiple unsuccessful attempts to input the unlock pattern. For example, after a certain number of unsuccessful attempts, the computing device may responsively disable the lock-screen for a certain period of time (referred to herein as a “lockout period”), such that the user cannot unlock the device.

Further, if additional unsuccessful attempts are made after the lockout period ends, the computing device may increase the duration of a subsequent lockout period. As a specific example, a computing device could lock a user out for one minute after five unsuccessful attempts, for an hour after five more unsuccessful attempts (e.g., ten unsuccessful attempts in total), for a day after five more unsuccessful attempts (e.g., fifteen unsuccessful attempts in total), and so on. Other examples are also possible.

In another aspect, a computing device may provide audio feedback indicating when the user has correctly inputted each image location and/or each image path in an unlock pattern. Additionally or alternatively, a computing device may provide audio feedback indicating when the user has correctly provided the entire sequence making up the unlock pattern and/or indicating when the user has made an error.

In a further aspect, the size and or shape of the input region may vary. Similarly, the graphical representation of the input region in a lock-screen may vary. For instance, while FIGS. 4, 5A to 5D, 7, and 9 show lock-screens that include a circular icon for the input region, differently shaped and/or differently sized graphical icons may be utilized to visually represent the input region. Other variations to the input region and/or the visual representation of the input region are also possible.

### V. Conclusion

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. (canceled)

2. (canceled)

3. The method of claim 17 4-9, wherein the plurality of gestures comprises a plurality of tap gestures.

4. The method of claim 17, further comprising, causing the display of the computing device to display a graphic indication at each of the locations in the input pattern.

5. The method of claim 17, wherein each location in the predetermined unlock pattern corresponds to a particular image feature.

6. The method of claim 17, wherein the gesture data corresponding to a plurality of touch gestures comprises gesture data corresponding to one or more first touch gestures and gesture data corresponding to one or more second touch gestures.

7. A non-transitory computer readable medium having stored therein instructions executable by a computing device to cause the computing device to perform functions comprising:
while the computing device is locked, displaying, on a near-eye display of a head-mountable device (HMD), an image and an input region that is moveable over the image;
receiving head-movement data that is indicative of head movement;
based at least in part on head-movement data, determining one or more movements of the input region with respect to the image;
receiving gesture data corresponding to a plurality of touch gestures on a capacitive touch-based interface of the HMD, wherein the gesture data is received during the one or more movements of the input region with respect to the image and wherein the capacitive touch-based interface is arranged at a different location on the HMD from the near-eye display;
determining an input pattern, wherein the input pattern comprises a sequence that includes a plurality of locations in the image and a second path through the sequence of locations that is defined at least in part by the one or more movements of the input region, wherein each location in the sequence is a location of the input region in the image at or near a time of a corresponding one of the touch gestures;
determining whether or not the input pattern matches a predetermined unlock pattern, wherein the predetermined unlock pattern comprises a predetermined sequence of two or more locations in the image and a predetermined first path through the predetermined sequence of two or more locations in the image,
wherein determining whether or not the input pattern matches a predetermined unlock pattern comprises: (a) determining whether or not the sequence of locations included in the input pattern matches the predetermined sequence of two or more locations in the image, (b) determining a fit of second path to the first path, and (c) based on the determined fit, determining that the second path has less than a threshold amount of deviation from the first path;
if the input pattern matches the predetermined unlock pattern, causing the computing device to unlock; and
if the input pattern does not match the predetermined unlock pattern, then refraining from unlocking the computing device.

8. (canceled)

9. The non-transitory computer readable medium of claim 7:
wherein the gesture data corresponds to one or more first touch gestures and one or more second touch gestures;
wherein each location in the input-pattern sequence is a location of the input region in the image at or near a time of a corresponding one of the one or more first touch gestures; and
wherein the second path further includes one or more sub-paths in the image, wherein each sub-path in the input-pattern sequence corresponds to movement of input region with respect to the image during a corresponding one of the one or more second touch gestures.

10. The non-transitory computer readable medium of claim 9, wherein the one or more first touch gestures comprise one or more first gestures on the capacitive touch-based interface, and wherein the one or more second gestures comprise one or more second touch gestures on the capacitive touch-based interface.

11. The non-transitory computer readable medium of claim 10, wherein the one or more first touch gestures on the touch-based interface comprise one or more tap gestures, and wherein the one or more second touch gestures on the capacitive touch-based interface comprise one or more tap-and-hold gestures.

12. A computing device comprising:
a near-eye display;
a non-transitory computer readable medium; and
program instructions stored on the non-transitory computer readable medium and executable by at least one processor to:
while the computing device is locked, cause the near-eye display to display an image and an input region that is moveable over the image;
receive head-movement data that is indicative of head movement;
based at least in part on head-movement data, determine one or more movements of the input region with respect to the image;
during the one or more movements of the input region with respect to the image, receive gesture data corresponding to a plurality of touch gestures on a capacitive touch-based interface of the computing device, wherein the capacitive touch-based interface is arranged at a different location on the computing device from the near-eye display;
determine an input pattern, wherein the input pattern comprises a sequence that includes a plurality of locations in the image and a second path through the sequence of locations that is defined at least in part by the one or more movements of the input region, wherein each location in the sequence is a location of the input region in the image at or near a time of a corresponding one of the touch gestures;
determine whether or not the input pattern matches a predetermined unlock pattern, wherein the predetermined unlock pattern comprises a predetermined sequence of two or more locations in the image and a predetermined first path through the predetermined sequence of two or more locations in the image,
wherein determining whether or not the input pattern matches a predetermined unlock pattern comprises: (a) determining whether or not the sequence of locations included in the input pattern matches the predetermined sequence of two or more locations in the image, (b) determining a fit of second path to the first path, and (c) based on the determined fit, determining that the second path has less than a threshold amount of deviation from the first path; and
based on the determination as to whether or not the input pattern matches the predetermined unlock pattern, determine whether or not to unlock the computing device.

13. The computing device of claim 12, wherein the device is implemented in or takes the form of a head-mountable device (HMD).

14. (canceled)

15. The computing device of claim 12:
wherein the gesture data corresponds to one or more first touch gestures and one or more second touch gestures;
wherein each location in the input-pattern sequence is a location of the input region in the image at or near a time of a corresponding one of the one or more first touch gestures; and
wherein the second path includes one or more sub-paths in the image, wherein each sub-path in the input-pattern sequence corresponds to movement of input region with respect to the image during a corresponding one of the one or more second touch gestures.

16. The computing device 12, wherein the one or more first touch gestures comprise one or more first touch gestures on the capacitive touch-based interface, and wherein the one or more second touch gestures comprise one or more second touch gestures on the capacitive touch-based interface.

17. A computer-implemented method comprising:
while a computing device is locked, causing a near-eye display of the computing device to display an image and an input region that is moveable over the image;
based at least in part on head-movement data, determining one or more movements of the input region with respect to the image;
during the one or more movements of the input region with respect to the image, receiving gesture data corresponding to one or more first touch gestures on a capacitive touch-based interface of the computing device and one or more second touch gestures on the capacitive touch-based interface of the computing device, wherein the capacitive touch-based interface is arranged at a different location on the computing device from the near-eye display;
determining an input pattern that comprises a sequence that includes both: (a) one or more locations in the image, each location in the sequence is a location of the input region in the image at or near a time of a corresponding one of the one or more first touch gestures, and (b) one or more paths in the image, wherein each path corresponds to movement of input region with respect to the image during a corresponding one of the one or more second touch gestures;
determining whether or not the input pattern matches a predetermined unlock pattern, wherein the predetermined unlock pattern comprises a predetermined sequence of at least one location in the image and at least one path in the image,
wherein determining whether or not the input pattern matches the predetermined unlock pattern comprises: (a) determining whether or not the sequence of locations included in the input pattern matches the predetermined sequence, (b) determining a fit of one or paths defined by the input pattern to the at least one path from the unlock pattern, and (c) based on the determined fit, determining that the one or paths defined by the input pattern have less than a threshold amount of deviation from the at least one path from the unlock pattern; and
based on the determination as to whether or not the input pattern matches the predetermined unlock pattern, determining whether or not to unlock the computing device.

18. (canceled)

19. A computer-implemented method comprising:
while a computing device is locked, causing a near-eye display of the computing device to display an image and an input region that is moveable over the image, wherein a predetermined unlock pattern comprises both a predetermined sequence of three or more locations in the image and a first path comprising a predetermined path through the predetermined sequence of three or more locations in the image;
receiving head-movement data that is indicative of head movement;
based at least in part on the head-movement data, determining one or more movements of the input region with respect to the image;
determining a second path through the image that is defined at least in part by the one or more movements of the input region;
determining that the second path both comprises the predetermined sequence of the three or more locations in the image and matches the predetermined first path through the predetermined sequence of three or more locations in the image, and responsively unlocking the computing device,
wherein the determination that the second path matches the predetermined first path comprises: (a) determining a fit of second path to the first path, and (b) based on the determined fit, determining that the second path has less than a threshold amount of deviation from the first path; and
responsive to determining that the second path both comprises the predetermined sequence of the three or more locations and matches the predetermined first path, unlocking the computing device.

20. (canceled)

21. The method of claim 19, wherein determining the second path through the image further comprises determining a path of the input region between a start location and an end location.

22. The method of claim 19, wherein determining that the second path matches the first path comprises:
determining that the second path includes the predetermined sequence of the three or more locations in the image; and
responsive to determining that the second path includes the predetermined sequence of the three or more locations in the image, determining that the second path matches the first path.

23. (canceled)

24. The method of claim 17, wherein determining the fit of second path to the first path comprises comparing directional attributes of the second path to the first path.

25. The method of claim 17, wherein determining the fit of second path to the first path comprises comparing curvature of the second path to the first path.

26. The method of claim 17, wherein determining the fit of second path to the first path comprises comparing a shape of the second path to the first path.
